(19) United States
(12) Patent Application Publication
(10) Pub. No.: US 2018/0136489 A1
(43) Pub. Date: May 17, 2018

(54) LOUPE AS WELL AS EYEGLASSES COMPRISING SUCH A LOUPE

(71) Applicant: MeridentOptergo AB, Mölnlycke (SE)

(72) Inventor: Björn Hellström, Mölnlycke (SE)

(73) Assignee: MeridentOptergo AB, Mölnlycke (SE)

(21) Appl. No.: 15/572,610

(22) PCT Filed: Apr. 25, 2016
(86) PCT No.: PCT/SE2016/050366

§ 371 Date: Nov. 8, 2017

(30) Foreign Application Priority Data
May 13, 2015 (SE) 1550619-9

(51) Int. Cl. G02C 7/08; G02B 25/00; G02C 9/00

(52) U.S. Cl. CPC G02C 7/088; G02B 25/004; G02C 9/00; G02B 25/007

(57) ABSTRACT

A loupe provides a magnification that is equal to or more than three and that is equal to or less than six. The loupe includes a housing, an objective lens arrangement arranged in the housing adjacent a first opening, an ocular lens arrangement arranged in the housing adjacent a second opening, and an optics arrangement arranged in the housing and located between the objective lens arrangement and the ocular lens arrangement. An optical center axis extends from the objective lens arrangement to the ocular lens arrangement via the optics arrangement. The optical center axis includes an objective lens axis and an ocular lens axis. The objective lens axis intersects the ocular lens axis in an acute angle α, where α≥10° and α≤20°, and the optics arrangement includes a mirror and a prism.

### TECHNICAL FIELD OF THE INVENTION

The present invention relates in general to a loupe, or binocular, configured for magnifying an object that is handled by the hands of the user/wearer and that is located below the normal visual field of the user. The loupe is especially intended to be used by dentists, surgeons, etc. performing a work requiring great precision on/at the object.

According to a first aspect the present invention relates specifically to a loupe that is intended to be mounted at an eyeglasses lens, the loupe providing a magnification that is equal to or more than three and that is equal to or less than six, and the loupe comprising a housing having a first opening and a second opening, an objective lens arrangement arranged in the housing adjacent said first opening, an ocular lens arrangement arranged in the housing adjacent said second opening, an optics arrangement arranged in the housing and located between said objective lens arrangement and said ocular lens arrangement, wherein an optical center axis extends from said objective lens arrangement to said ocular lens arrangement via said optics arrangement. According to a second aspect the present invention relates to a pair of eyeglasses comprising at least one eyeglasses lens and such a loupe.

### BACKGROUND OF THE INVENTION AND PRIOR ART

Patients of the dentist or the surgeon are often lying down on their back and the dentist/surgeon is standing or sitting close to the patient in order to be able to perform the intended operation without having to work with the arms in an non-ergonomic position. However, this entail that the patient/object is located below the normal visual field of the observer, the observer being forced to angle the head forward in an injurious angle in order to be able to see the object, at the same time as the object that is typically small is located at a too great distance for obtaining the intended precision.

Loupes that magnifies the object being handled and that by means of prisms or mirrors redirects the optical center axis are known. These loupes entail that the user must not angle the head forward in an injurious angle at the same time as appropriate magnification is obtained.

An example of such a loupe is disclosed in U.S. Pat. No. 5,923,467 (Pericic), in which the redirection angle is in the range 30-60 degrees, preferably 45 degrees. The loupe is arranged in such a way that the observer/user must look straight forward in parallel with a horizontal plane in the room, i.e. the eyes of the user shall be located in an unrotated position and the head of the user shall not be angled forward but be located entirely straight up. However, this loupe is heavy and its center of gravity is located far forward resulting in great local stress/discomfort at the neck, ears and nose of the user. The great redirection and the fact that the user looks straight forward entail that the user will have great problems of learning, and must constantly struggle to master, to move the hands correctly in relation to the object in an unnatural way for the brain. The brain of the user has great problems of match that the arms/hands work close to the body and that the head of the user is in an upright position and the eyes are looking straight forward. The user may neither easily switch between looking at the surrounding/colleagues without the loupe and looking at the object using the loupe, respectively, as a consequence of the loupe obstructing the view.

U.S. Pat. No. 6,120,145 (Lyst) disclose a system that comprises a loupe lacking a redirection angle as well as a redirection unit arranged in front of the loupe. The redirection unit is disclosed in different embodiments and the redirection angles in these embodiments are within the range 25-60 degrees. This system is very nose-heavy as the loupe is a straight loupe and the redirection unit is arranged in front of the loupe and this entail great stress/discomfort at the neck of the user.

U.S. Pat. No. 4,652,094 disclose a loupe system having a detachable redirection unit, and when the redirection unit is not used the loupe is a straight loupe. The loupe system disclosed has redirection angles in the range 30-90 degrees when the redirection unit is used. This loupe system is arranged to be attached to the eyeglasses and is long and heavy due to the detachable redirection unit, leading to great local stress/discomfort at the neck, ears and nose of the user.

### OBJECT OF THE INVENTION

The present invention aims at obviating the aforementioned disadvantages and failings of previously known loupes, and at providing an improved loupe. A primary object of the present invention is to provide an improved loupe of the initially defined type, which is compact and light and thereby decrease the local stress/discomfort at the neck, ears and nose of the user when the loupe is attached at a pair of eyeglasses.

It is another object of the present invention to provide a loupe and eyeglasses, wherein the loupe does not obstruct the visual field of the user when the user is looking straight forward.

It is another object of the present invention to provide a loupe, which entail that the user rotates the eyes downwards from a basic position which in its turn entails that the eyes of the user automatically rotates inwards (converges) and at the same time the displacement in the height direction between the real object and the perceived image of the object is reduced, thereby simplifying for the brain of the user to automatically prepare for controlling the hands to handle an object located close to the body/trunk of the user.

### BRIEF DESCRIPTION OF THE INVENTION

According to the invention at least the primary object is attained by means of the initially defined loupe and eyeglasses, having the features defined in the independent claims. Preferred embodiments of the present invention are further defined in the dependent claims.

According to a first aspect of the present invention, there is provided a loupe of the initially defined type, which is characterized in that the optical center axis comprises an objective lens axis and an ocular lens axis, said objective lens axis intersecting said ocular lens axis in an acute angle α, where α≥10° and α≤20°, and in that said optics arrangement comprises a mirror and a prism. According to a second aspect of the present invention, there is provided a pair of eyeglasses comprising at least one such loupe.

Thus, the present invention is based on the understanding that the loupe and eyeglasses are arranged in such a way that the user shall rotate the eyes downwards, and thereby automatically inwards, which in combination with a redirection angle in the range 10 to 20 degrees entails that the user must angle the head forward but not to an injurious extent. The light and compact design entail that the user does not experience discomfort while using the loupe. All together entails that the brain of the user easily can handle the visual impression and the user can easily control the motor activity to perform the intended work requiring great precision. A redirection angle greater than 20 degrees in the loupe entail that the user will have great problems during learning of using the loupe as well as shifting between working with and without the loupe, respectively.

The use of a prism in the optics arrangement entail for instance that the loupe can be made more compact and the use of a mirror in the optics arrangement entail for instance that the need to compensate for color offset errors in the loupe is minimized.

According to a preferred embodiment of the present invention, the mirror of the optics arrangement is located between said objective lens arrangement and the prism of the optics arrangement. This design entail that the user easily can see above the loupe.

According to a preferred embodiment the prism of the optics arrangement is constituted by a roof pentaprism. This entail that the loupe can be made very compact, thanks to the prolonged beam path in the actual roof pentaprism.

Preferably the loupe is arranged in a through hole in said eyeglasses lens of the eyeglasses. This entail that the center of gravity of the loupe can be moved as close to the eye of the user as possible.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic perspective view from below/front of an inventive loupe,

FIG. 2 is a schematic perspective view from above/back of the inventive loupe according to FIG. 1,

FIG. 3 is a schematic cross sectional side view of the loupe according to FIGS. 1 and 2,

FIG. 4 is a schematic cross sectional exploded view of the loupe according to FIGS. 1 and 2,

FIG. 5 is a schematic side view of an inventive pair of eyeglasses comprising at least one loupe, and

FIG. 6 is a schematic view from above of the eyeglasses according to FIG. 5.

### DETAILED DESCRIPTION OF PREFERRED EMBODIMENTS OF THE INVENTION

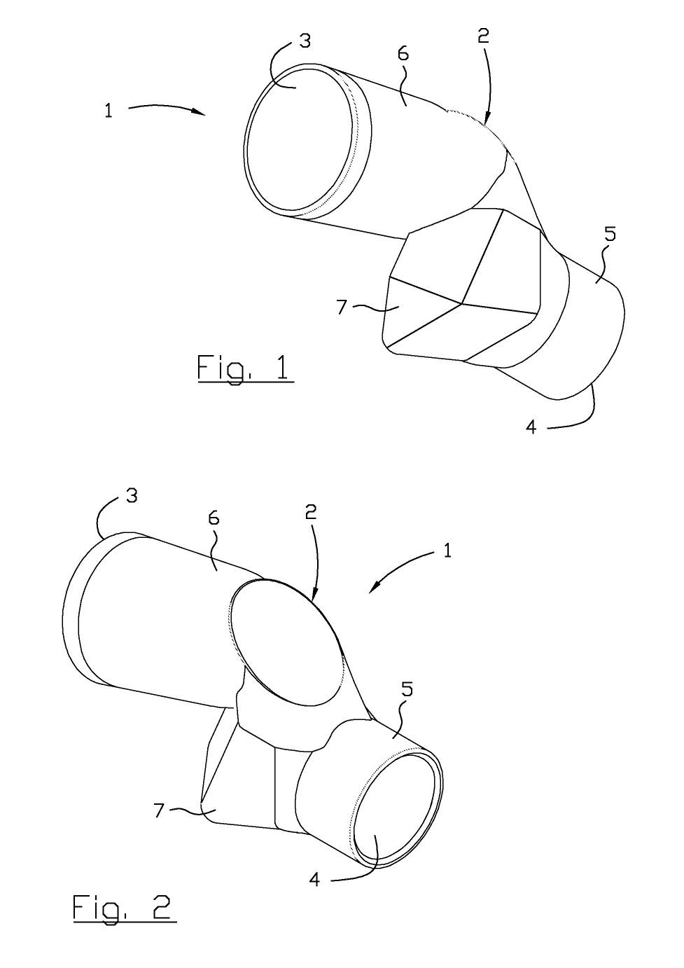

Initially reference is made to FIGS. 1 and 2. The present invention relates in general to a loupe, generally designated 1, also known as binocular, microscope, etc. The loupe 1 is arranged to be used by a user and follow the movements of the head of the user in order to provide a magnification of the object that the user wish to obtain a magnified image. The loupe 1 according to the present invention provides a magnification that is equal to or greater than three and that is equal to or less than six, preferably the loupe 1 provides a magnification that is equal to about four. The loupe 1 is of Kepler type, i.e. comprises positive lens systems in the objective as well as in the ocular, in order to obtain an as compact loupe as possible.

The loupe 1 comprises a housing, generally designated 2, having a first opening 3 and a second opening 4. The first opening 3 and the second opening 4 are in communication with each other via the inner cavity of the housing 2. Said second opening 4 (the proximal opening of the loupe 1) is arranged to be located adjacent the eye of the user and said first opening 3 (the distal end of the loupe 1) is arranged to be located closest to the object to be observed. In connection to the second opening 4 the housing 2 preferably comprises a cylinder-shaped pipe 5 and in connection to the first opening 3 the housing 2 preferably comprises a funnel-shaped pipe 6 having the largest outer diameter at the first opening 3. It shall be pointed out that the funnel-shaped pipe 6 preferably presents a cylinder-shaped inner surface and in an alternative embodiment the funnel-shaped pipe 6 may be constituted by (exchanged with) a cylinder-shaped pipe. Thereto the housing 2 comprises an intermediate housing body 7 connecting the cylinder-shaped pipe 5 and the funnel-shaped pipe 6.

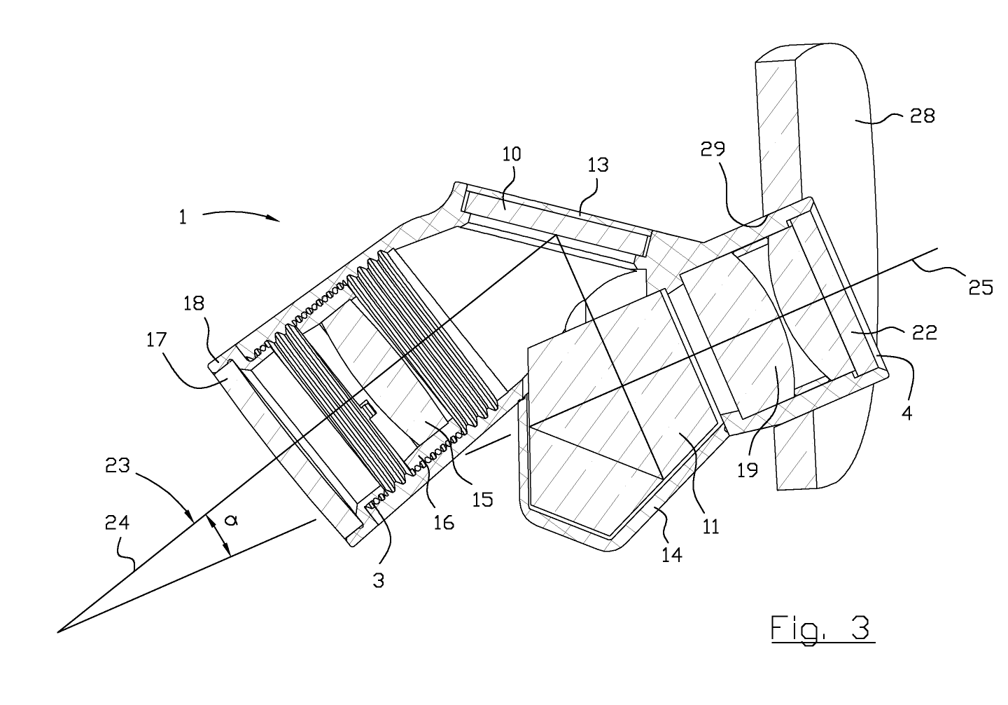

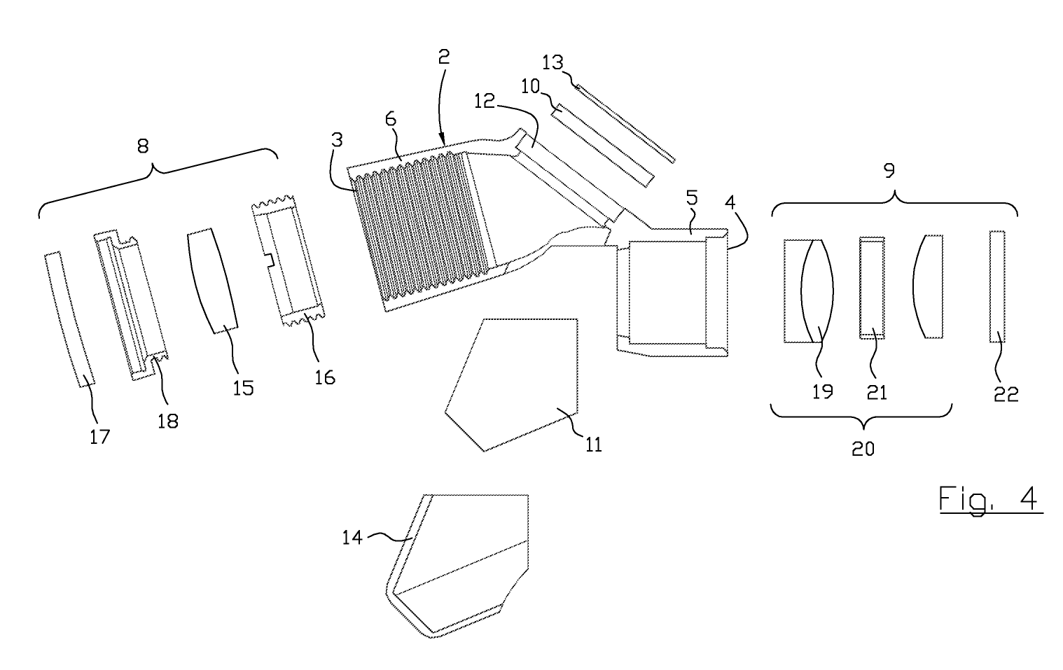

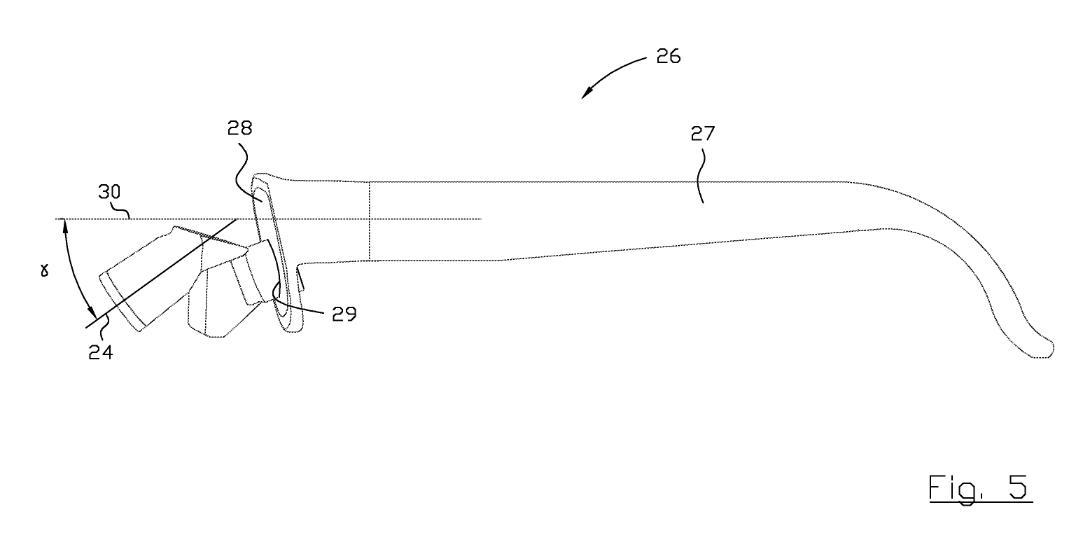

Reference is now primarily made to FIGS. 3 and 4, disclosing a schematic cross sectional side view and a schematic cross sectional exploded view seen from the side, respectively, of a preferred embodiment of the inventive loupe 1.

The loupe 1 comprises an objective lens arrangement, generally designated 8, arranged in the housing 2 adjacent the first opening 3 of the housing 2, more precisely the objective lens arrangement 8 is arranged in the funnel-shaped pipe 6 of the housing 2, the funnel-shaped pipe is also known as objective. Thereto the loupe 1 comprises an ocular lens arrangement, generally designated 9, arranged in the housing 2 adjacent the second opening 4 of the housing 2, more precisely the ocular lens arrangement 9 is arranged in the cylinder-shaped pipe 5 of the housing 2. Thereto the loupe 1 comprises an optics arrangement arranged in the housing and located between said objective lens arrangement 8 and said ocular lens arrangement 9, more precisely the optics arrangement is arranged in the intermediate housing body 7 of the housing 2. It is essential for the invention that the optics arrangement comprises a mirror 10 and a prism 11. The mirror is a plane/flat mirror. The mirror 10 has at least de advantages of low weight, small size and no color offset errors in the reflection. The mirror 10 provides one reflection turning the image in the direction up-down. The prism 11 is preferably constituted by a roof pentaprism, which at least has the advantage that it provides a relatively prolonged beam path in a small area, which entails that the loupe 1 can provide large magnification and still presents a small and compact size. The roof pentaprism 11 provides one image shift in the direction right-left and two reflections turning the image in the direction up-down, which together with the reflection of the mirror 10 in the direction up-down turns the image correct for the user.

The plane mirror 10 is located in a seat 12 arranged in the intermediate housing body 7 of the housing 2, a lid 13 forming part of the housing 2 and keeping the mirror 10 in place in the seat 12. The lid 13 may be detachable in order to admit exchange of the mirror 10 if it is damaged. The mirror 10 is preferably located between the prism 11 of the optics arrangement and the objective lens arrangement 8. The prism 11 is arranged in a holder 14, that is part of the housing 2 and that is fixedly or detachably connected to the rest of the intermediate housing body 7 of the housing 2 in a suitable way. It shall be realized that it is of great importance that the mirror 10 and the prism 11 must not be able to change their respective positions when the loupe 1 is in the mounted state.

The objective lens arrangement 8 comprises at least one objective lens 15, preferably of biconvex type, that in the disclosed embodiment is connected to a runner 16. It shall be realized that the objective lens arrangement 8 may comprise a plurality of objective lenses in order to obtain different degrees of color correction and different degrees of magnification. The runner 16 is displaceable back and forth in relation to the first opening 3 of the housing 2, more precisely the runner 16 is displaceable back and forth in the funnel-shaped pipe 6 of the housing 2. Preferably, the outer surface of the runner 16 is provided with an external thread that is in engagement with an internal thread arranged at the inner surface of the funnel-shaped pipe 6 of the housing 2. Thus, the position of the objective lens 15 and the runner 16 in relation to the first opening 3 of the housing 2, and thereby in relation to the ocular lens arrangement 9, be adjusted based on the distance between the eye of the user and the object and based on the visual acuity of the user. The distance between the object and the objective lens 15 is preferably in the range 350-600 millimeters, most preferably about 450 millimeters, but is determined from the physical conditions and wishes of the individual user. In order for the user to have an ergonomic position it is preferred that the upper arms of the user shall vertically directed and the elbows shall be located adjoining the trunk. Thereto it is preferred that the hands of the user in the height direction shall be located between the breasts and the navel.

Thereto the objective lens arrangement 8 preferably comprises a protective lens 17 that is connected to protective lens holder 18 that in its turn is arranged at the first opening 3 of the housing 2. The protective lens 17 has preferably no refraction but presents uniform thickness over the entire lens, and is preferably of meniscus type. The protective lens 17 protects the objective lens 15 for instance from mechanical stress such as splash of liquids from the object and scratches from cleaning, and from chemical stress such as degradation of the AR-coating of the objective lens 15. Preferably the runner 16 is not accessible after the protective lens 17 has been mounted to the loupe 1. The protective lens holder 18 is in the disclosed embodiment in threaded engagement with the funnel-shaped pipe 6 of the housing 2.

In a non-disclosed alternative embodiment the runner 16 may be arranged to be directly or indirectly manipulated from the outside of the housing 2 when the protective lens 17 is mounted to the loupe 1.

The ocular lens arrangement 9 comprises at least one ocular lens 19. The ocular lens arrangement 9 may comprise different predetermined ocular types, such as Kepler, Plössl, König, Kellner, etc. or variants thereof, or personally combined oculars. In the disclosed embodiment the ocular lens arrangement 9 comprises an inverse Kellner ocular 20 having a plurality of ocular lenses as well as a distance ring 21. Different types of ocular lens arrangements and different numbers of lenses in the ocular lens arrangement provides different degree of color correction and different degree of magnification. Thereto the ocular lens arrangement 9 preferably comprises a corrective lens 22, which is arranged to provide a compensation for the possible astigmatic visual defect of the user as well as supplement the setting/adjustment of the position of the objective lens 15 in relation to the first opening 3 of the housing 2.

It is essential for the present invention that an optical center axis, generally designated 23, extend from said objective lens arrangement 8 to said ocular lens arrangement 9 via said optics arrangement, the optical center axis 23 comprising an objective lens axis 24 and an ocular lens axis 25, and said objective lens axis 24 intersecting said ocular lens axis 25 in an acute angle α, where α is equal to or greater than 10° and α is equal to or less than 20°. The mutual inclination/orientation of the mirror 10 of the optics arrangement and the prism 11 of the optics arrangement determine the size of the angle α. It shall be realized that the optical center axis 23 extend all the way from the object to the eye of the user.

Preferably, the angle α between the objective lens axis 24 and the ocular lens axis 25 is equal to or greater than 12°, preferably equal to or greater than 14°. Preferably the angle α between the objective lens arrangement 24 and the ocular lens arrangement 25 is equal to or less than 18°, preferably equal to or less than 16°. Most preferably the angle α is equal to 15°. This will be further explained hereinafter.

Reference is now primarily made to FIG. 5, that discloses a side view of an inventive pair of eyeglasses, generally designated 26, comprising at least one inventive loupe 1. However, it shall be pointed out that the eyeglasses 26 usually comprise two such loupes 1, one for each eye of the user.

The eyeglasses 26 according to the disclosed embodiment comprises a conventional spectacle frame 27 and at least one eyeglasses lens 28, the loupe 1 being arranged at said eyeglasses lens 28, also known as carrier lens, and attached thereto by means of a suitable adhesive, such as UV-curing glue. Preferably the loupe 1 is arranged in a through hole 29 of the eyeglasses lens 28, entailing that the distance between the pupil and/or retina of the eye of the user and the ocular lens arrangement 9 may be minimized which in its turn entails that the loupe 1 can be made more compact. It shall be pointed out that the eyeglasses lens 28 can be made with or without optical power/degree of refraction/grinding, depending on the general visual status of the user. An advantage of the loupe 1 being connected to the eyeglasses lens 28 is that a well defined and user adapted/individualized distance between the loupe 1 and the pupil and/or retina of the eye of the user can be obtained, at the same time as the user simply can take the eyeglasses 26 off and put them on repeatedly without effecting the cooperation between the loupe 1 and the eye. According to a non disclosed alternative embodiment the loupe 1 is attached to another unit that is configured to be carried by the user, for instance a headband like or helmet like unit, eyeglasses frames without eyeglasses lenses, etc.

The user and the object are located in an object space, and when the user takes a reference position, i.e. does not angle the head in any direction and at the same time look straight ahead, both eyes of the user are located in and look along a horizontal reference plane in the object space. The eyeglasses 26 has an imaginary horizontal plane 30, that is in parallel with said horizontal reference plane in the object space when the user carrying the eyeglasses 26 takes said reference position. When the user angle the head forward for instance 10 or 15 degrees, this entail that the imaginary horizontal plane incline 10 or 15 degrees, respectively, downwards in relation to the horizontal reference plane in the object space. If the user has a head angle more than 25 degrees forward during long periods the risk of having so-called musculoskeletal disorder is considerably increased. A head angle in the range 10-15 degrees is preferable for the user to be able to work long periods having the same head angle/position. The loupe 1 is preferably entirely located below the abovementioned horizontal reference plane in the object space when the user carrying the eyeglasses 26 takes said reference position.

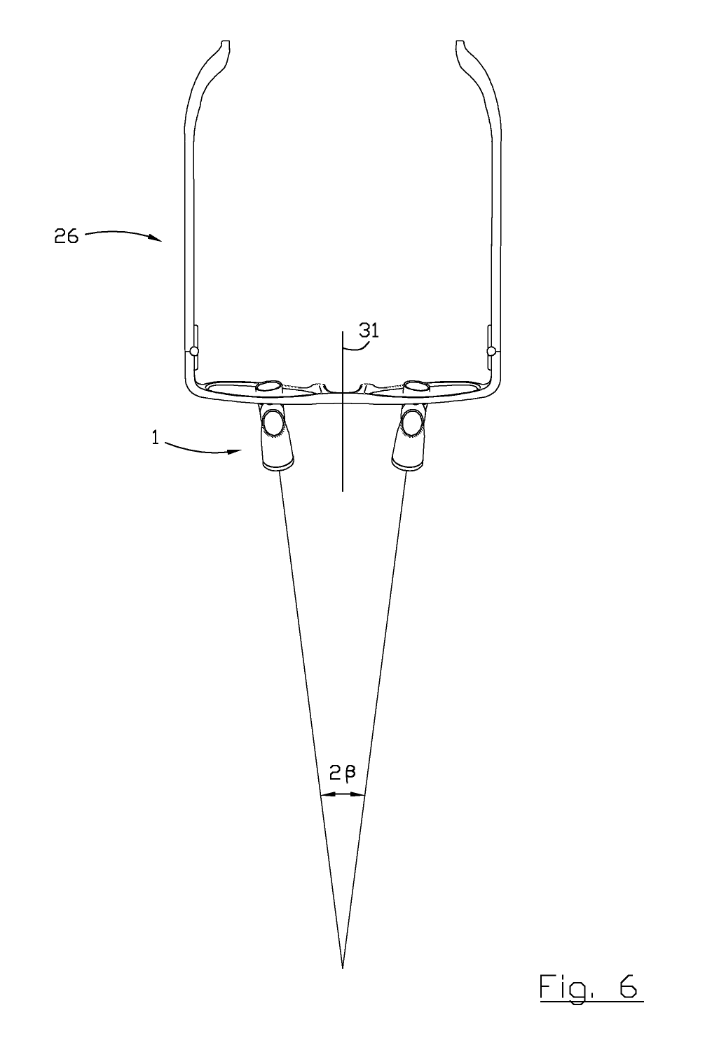

Reference is now also made to FIG. 6 disclosing an elevated view from above of a pair of inventive eyeglasses 26 comprising two loupes 1.

The eyeglasses 26 has an imaginary vertical plane 31 dividing the eyeglasses 26 in a right side and a left side seen in the direction of sight of the user and intersecting the imaginary horizontal plane 30 perpendicularly. The mutual distance between the respective second openings 4 of the two loupes 1 is user adapted and is preferably in the range 50-75 millimeters. This together with the distance between the object and the loupes 1 entail that the optical center axis 23 of the individual loupe 1 intersect said imaginary vertical plane 31 in an acute angle β, seen perpendicular to said imaginary horizontal plane 30, where β is equal to or greater than 2° and β is equal to or less than 7°. It shall be pointed out that in FIG. 6 the angle 2β is disclosed, thus being in the range 4°-14°.

Thereto each loupe 1 is inclined in relation to the imaginary horizontal plane 30 of the eyeglasses 26 in such a way that the objective lens axis 24 of the loupe 1 intersect said imaginary horizontal plane 30 in an angle γ, seen perpendicular to said imaginary vertical plane 31, where γ is equal to or greater than 20° and γ is equal to or less than 50°. Thereto the angle γ shall be strict greater than the angle α. This entail that the user rotates the eyes downwards in a rotational angle equal to γ-α in order to look straight into the second opening 4 of the loupe 1. An untrained user can without effort work in a position in which the eyes are rotated up to 30 degrees downwards, at the same time as a trained user without great effort can work in a position in which the eyes are rotated up to 40 degrees downwards. A great advantage of having the eyes of the user rotated downwards is that the eyes also automatically rotates inwards and thereby looks straight into the loupes 1 that are angled in relation to the imaginary vertical plane 31.

If the angle α between the objective lens axis 24 and the ocular lens axis 25 is less than 10° the user must angle the head forward too much, or rotate the eyes downwards in an unnatural/straining degree. If the angle α between the objective lens axis 24 and the ocular lens axis 25 is more than 20° it will be very difficult to accustom and the user require a lot of practice for the brain of the user to coordinate the visual impressions and the movements of the hands. It will also be harder for the user to switch between working with and without the loupe, respectively.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and thus, the equipment may be modified in all kinds of ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

1.-11. (canceled)

12. A loupe for mounting to an eyeglasses lens, the loupe providing a magnification that is greater than or equal to three and that is less than or equal to six, said loupe comprising:
a housing having a first opening and a second opening,
an objective lens arrangement arranged in the housing adjacent said first opening,
an ocular lens arrangement arranged in the housing adjacent said second opening,
an optics arrangement comprising a mirror and a prism arranged in the housing and located between said objective lens arrangement and said ocular lens arrangement,
wherein an optical center axis extends from said objective lens arrangement to said ocular lens arrangement via said optics arrangement,
wherein said optical center axis comprises an objective lens axis and an ocular lens axis, said objective lens axis intersecting said ocular lens axis at an acute angle α, wherein α≥10 degrees and α≤20 degrees.

13. The loupe according to claim 12, wherein α≥12 degrees.

14. The loupe according to claim 12, wherein α≤18 degrees.

15. The loupe according to claim 12, wherein the mirror of the optics arrangement is located between said objective lens arrangement and the prism of the optics arrangement.

16. The loupe according to claim 12, wherein the ocular lens arrangement comprises at least one corrective lens.

17. The loupe according to claim 12, wherein the prism of the optics arrangement is a roof pentaprism.

18. The loupe according to claim 12, wherein the objective lens arrangement comprises an objective lens configured to be displaced back and forth along said objective lens axis in relation to the first opening of the housing.

19. Eyeglasses comprising at least one eyeglasses lens comprising the loupe of claim 12.

20. The eyeglasses according to claim 19, wherein the loupe is arranged in a through-hole in said eyeglasses lens.

21. The eyeglasses according to claim 19, wherein a vertical reference plane divides the eyeglasses into a right side and a left side and lies perpendicular to a horizontal reference plane, wherein the optical center axis of the loupe intersects said vertical plane in an acute angle β, as viewed perpendicular to said horizontal plane, where β≥2 degrees and β≤7 degrees.

22. The eyeglasses according to claim 19, wherein a vertical plane divides the eyeglasses into a right side and a left side and lies perpendicular to a horizontal reference plane, and wherein the objective lens axis intersects said imaginary horizontal plane in an angle γ, as viewed perpendicular to said vertical plane, where γ≥20 degrees and γ≤50 degrees.

23. The eyeglasses according to claim 21, wherein the eyeglasses are configured to be worn by a wearer in a reference position relative to eye locations of the wearer, and the horizontal reference plane is defined by the eye locations in the reference position.

24. The eyeglasses according to claim 22, wherein the eyeglasses are configured to be worn by a wearer in a reference position relative to eye locations of the wearer, and the horizontal reference plane is defined by the eye locations in the reference position.
